(19) United States
(12) Patent Application Publication
(10) Pub. No.: US 2026/0362310 A1
(43) Pub. Date: Nov. 12, 2026

(54) COMMUNICATION METHODS FOR NETWORK FUNCTION SELECTION, COMMUNICATION DEVICE AND REPOSITORY ELEMENT

(71) Applicant: GUANGDONG OPPO MOBILE TELECOMMUNICATIONS CORP., LTD., Dongguan (CN)

(72) Inventor: Alla GOLDNER, Tel Aviv (IL)

(21) Appl. No.: 19/725,345

(22) Filed: Jun. 30, 2026

Related U.S. Application Data
(63) Continuation of application No. PCT/CN2024/071547, filed on Jan. 10, 2024.

(51) Int. Cl. H04W 48/18; H04W 8/22; H04W 24/02; H04W 48/16

(52) U.S. Cl. CPC H04W 48/18; H04W 8/22; H04W 24/02; H04W 48/16

(57) ABSTRACT

A communication method for network function (NF) selection includes utilizing, by a first NF, a repository element to discover at least one NF instance and providing, by the first NF, a user equipment (UE) location information to the repository element when trying to discover the at least one NF instance, wherein a NF selection functionality in the first NF selects a NF instance and a NF service instance based on the at least one NF instance, and the NF selection functionality includes an energy cost as an input parameter for NF selection.

### CROSS-REFERENCE TO RELATED APPLICATION

The present application is a continuation of International Application No. PCT/CN2024/071547, filed on Jan. 10, 2024, which is hereby incorporated by reference in its entirety.

### BACKGROUND

There is currently standardization activity in 3rd generation partnership project (3GPP) work studying a network function (NF) selection. However, in current technologies and/or standardizations, aspects for energy related NF selection are open issues.

Therefore, there is a need for apparatuses and communication methods for network function (NF) selection, which can address these issues and other issues.

### SUMMARY

The present disclosure relates to the field of communication systems, and more particularly, to a communication method for network function (NF) selection, a communication device and a repository element.

An object of the present disclosure is to propose a communication method for network function (NF) selection, a communication device and a repository element.

In a first aspect of the present disclosure, a communication method for network function (NF) selection includes utilizing, by a first NF, a repository element to discover at least one NF instance and providing, by the first NF, a user equipment (UE) location information to the repository element when trying to discover the at least one NF instance, wherein a NF selection functionality in the first NF selects a NF instance and a NF service instance based on the at least one NF instance, and the NF selection functionality includes an energy cost as an input parameter for NF selection.

In a second aspect of the present disclosure, a communication device includes a memory for storing instructions; a transceiver; and a processor coupled to the memory and the transceiver, the processor is configured to execute the instructions to utilize a repository element to discover at least one network function (NF) instance and provide a user equipment (UE) location information to the repository element when trying to discover the at least one NF instance, wherein a NF selection functionality in the communication device selects a NF instance and a NF service instance based on the at least one NF instance, and the NF selection functionality includes an energy cost as an input parameter for NF selection.

In a third aspect of the present disclosure, a repository element includes a memory for storing instructions, a transceiver, and a processor coupled to the memory and the transceiver. The repository element is configured to execute the instructions to receive a user equipment (UE) location information provided by a first network function (NF), the repository element is utilized by the first NE to discover at least one NF instance, a NF selection functionality in the first NF selects a NF instance and a NF service instance based on the at least one NF instance, and the NF selection functionality comprises an energy cost as an input parameter for NF selection.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of a 5G system architecture configured to implement some embodiments presented herein.

FIG. 2 is a block diagram of a network device according to an embodiment of the present disclosure.

FIG. 3 is a flowchart illustrating a communication method for network function (NF) selection according to an embodiment of the present disclosure.

FIG. 4 is a block diagram of a communication device according to an embodiment of the present disclosure.

FIG. 5 is a block diagram of an example of a computing device according to an embodiment of the present disclosure.

FIG. 6 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Energy cost is one of major challenges faced by the mobile technology. Network function (NF) selection is an important process used for selecting an appropriate NF for control plane and/or user plane when establishing or modifying protocol data unit (PDU) session. Some embodiments of the present disclosure introduce energy cost as one of factors for NF selection, that may be applied to 3rd generation partnership project (3GPP) release 19, therefore, NFs for specific PDU session would be selected also based on energy cost of corresponding nodes. Some embodiments of the present disclosure are applied to a 5G system and potentially may be also applied to a 6G system.

NF selection at a PDU session establishment is one of key technologies developed in 5G. There are different types of NFs. Additionally, as part of the work on artificial intelligence (AI)/machine learning (ML) for a Next Generation-Radio Access Network (NG-RAN), a new metric named energy cost is introduced in some embodiments. The energy cost provides a representation of an energy consumption at an NG-RAN node. NG-RAN nodes exchange the energy cost with neighbouring NG-RAN nodes upon a request. The energy cost is encoded as an index, normalized by rules provided by Operation Administration and Maintenance (OAM). These rules are the same at least for all neighbouring NG-RAN nodes within the area where a request on energy cost reporting is triggered by a NG-RAN node. Based on this, it is required that NG-RAN nodes are configured with a unified rule to map the energy cost value of the NG-RAN node to a measurement of consumed energy ensuring normalization of the exchanged energy cost information. It is assumed that the same principle of energy cost metric may be adopted for 5G Core Network Functions, and some embodiments of the present disclosure are based on this principle.

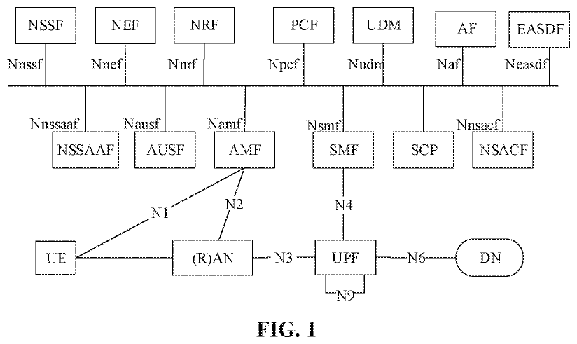

FIG. 1 illustrates a 5G system architecture configured to implement some embodiments presented herein. In the 5G system architecture as illustrated in FIG. 1, network functions communicate with each other over a service-based interface. The 5G system architecture includes the following network functions (NFs): Authentication Server Function (AUSF), Access and Mobility Management Function (AMF), Data Network (DN), e.g. operator services, Internet access or 3rd party services, Network Exposure Function (NEF), Network Repository Function (NRF), Network Slice Admission Control Function (NSACF), Network Slice-specific and SNPN Authentication and Authorization Function (NSSAAF), Network Slice Selection Function (NSSF), Policy Control Function (PCF), Session Management Function (SMF), Unified Data Management (UDM), User Plane Function (UPF), Application Function (AF), User Equipment (UE), (Radio) Access Network ((R)AN), Edge Application Server Discovery Function (EASDF), and Service Communication Proxy (SCP).

The following descriptions highlight some of the capabilities of the network functions (NFs) from FIG. 1 that are involved with control signaling.

Access and Mobility Function (AMF): The UE sends an N1 message through the RAN node to the AMF to perform control plane signaling such as registration, connection management, mobility management, access authentication and authorization, etc.

Session Management Function (SMF): The SMF is responsible for session management involved with establishing PDU sessions to allow UEs to send data to Data Networks (DNs) such as the internet or to an application server and other session management related functions.

Policy and Control Function (PCF): The PCF provides the policy framework that governs network behavior, accesses subscription information to make policy decisions, etc.

Network Exposure Function (NEF): The NEF supports the exposure of capabilities and events in the core network to third parties, Application Functions (AF), Edge Computing, etc.

The PCF/NEF stores/retrieves information related with policy subscription data or with application data. Further, the PCF in visited public land mobile network (VPLMN) may interact with the AF in order to generate policy and charging control (PCC) rules for services delivered via the VPLMN. The PCC rule may refer to a set of information enabling the detection of a service data flow and providing parameters for policy control and/or charging control and/or other control or support information. The PCF in the VPLMN uses locally configured policies according to the roaming agreement with the HPLMN operator as input for PCC Rule generation. The PCF in VPLMN has no access to subscriber policy information from the HPLMN for PCC Rule generation. The PCF in the VPLMN can provide access and motility policy information without contacting the PCF in the HPLMN. AF requests providing routing information for roamers targeting a DNN and S-NSSAI (targeting all roamers) or an External-Group-Identifier (identifying a group of roamers) are stored as Application Data in the UDR (in the VPLMN) by the NEF (in the VPLMN). AF requests influencing AM policy for roamers targeting any inbound roaming UEs together with combination(s) of DNN and S-NSSAI or External Application Identifier(s) are stored as Application Data in the UDR (in the VPLMN) by the NEF (in the VPLMN). The inbound roamers are identified by their home public land mobile network (PLMN) ID(s).

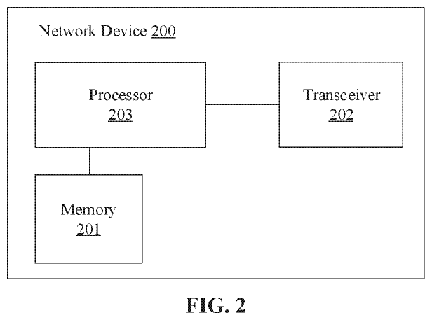

FIG. 2 illustrates an example of a network device 200 according to an embodiment of the present disclosure. The network device 200 is configured to implement some embodiments of the disclosure. Some embodiments of the disclosure may be implemented into the network device 200 using any suitably configured hardware and/or software. The network device 200 may include a memory 201, a transceiver 202, and a processor 203 coupled to the memory 201 and the transceiver 202. The processor 203 may be configured to implement proposed functions, procedures and/or methods described in this description. Layers of radio interface protocol may be implemented in the processor 203. The memory 201 is operatively coupled with the processor 203 and stores a variety of information to operate the processor 203. The transceiver 202 is operatively coupled with the processor 203, and the transceiver 202 transmits and/or receives a radio signal. The processor 203 may include application-specific integrated circuit (ASIC), other chipset, logic circuit and/or data processing device. The memory 201 may include read-only memory (ROM), random access memory (RAM), flash memory, memory card, storage medium and/or other storage device. The transceiver 202 may include baseband circuitry to process radio frequency signals. When the embodiments are implemented in software, the techniques described herein can be implemented with modules (e.g., procedures, functions, and so on) that perform the functions described herein. The modules can be stored in the memory 201 and executed by the processor 203. The memory 201 can be implemented within the processor 203 or external to the processor 203 in which case those can be communicatively coupled to the processor 203 via various means as is known in the art.

In some embodiments, the memory 201 stores executable instructions that when executed by the processor cause the processor 203 to effectuate operations including: utilizing a repository element to discover at least one NF instance and providing a user equipment (UE) location information to the repository element when trying to discover the at least one NF instance, wherein a NF selection functionality in the first NF selects a NF instance and a NF service instance based on the at least one NF instance, and the NF selection functionality includes an energy cost as an input parameter for NF selection.

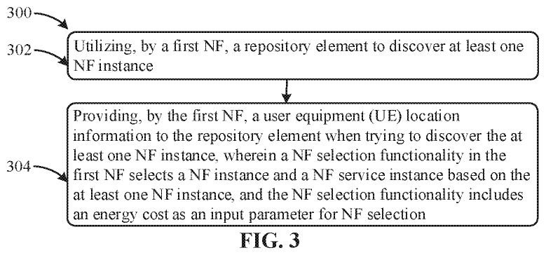

FIG. 3 illustrates a communication method for network function (NF) selection according to an embodiment of the present disclosure. FIG. 3 is an example of a communication method 300 for network function (NF) selection according to an embodiment of the present disclosure. The communication method 300 for network function (NF) selection is configured to implement some embodiments of the disclosure. Some embodiments of the disclosure may be implemented into the communication method 300 for network function (NF) selection using any suitably configured hardware and/or software. In some embodiments, the communication method 300 for network function (NF) selection includes: an operation 302, utilizing, by a first NF, a repository element to discover at least one NF instance, and an operation 304, providing, by the first NF, a user equipment (UE) location information to the repository element when trying to discover the at least one NF instance, wherein a NF selection functionality in the first NF selects a NF instance and a NF service instance based on the at least one NF instance, and the NF selection functionality includes an energy cost as an input parameter for NF selection.

In some embodiments, the first NF is an access and mobility management function (AMF), the repository element is a network repository function (NRF), and the NF selection is functionality a session management function (SMF) selection functionality, a user plane function (UPF) selection functionality, or an AMF selection functionality. In some embodiments, the energy cost is an index used to reflect an energy consumption of at least one SMF, at least one UPF, or at least one AMF. In some embodiments, the SMF selection functionality further includes at least one of following factors: a selected data network name (DNN), a single network slice selection assistance information (S-NSSAI), a network slice instance identifier (NSI-ID), an access technology being used by a UE, a support for control plane cellular internet-of-things (CIoT) fifth-generation system (5GS) optimization, a subscription information from a unified data management (UDM), local operator policies, load conditions of candidate SMFs, analytics for candidate SMFs' load as received from a network data analytics function (NWDAF) if the NWDAF is deployed, a UE location, a service area of the candidate SMFs, a capability of the SMF to support a multi-access (MA) protocol data unit (PDU) session, if interworking with Evolved Packet System (EPS) is required, a preference of visited SMF (V-SMF) support, a target data network access identifier (DNAI), a capability of the SMF to support user plane remote provisioning, a supported DNAI list, a HR-SBO support, and a capability of the SMF to support a non-3rd generation partnership project (3GPP) access path switching.

In some embodiments, the UPF selection functionality further includes at least one of following parameters: a UPF's dynamic load, analytics for UPF load, service experience analytics, data network (DN) performance analytics per user plane (UP) path, UE related analytics as received from a NWDAF if the NWDAF is deployed, a UPF's relative static capacity among UPFs supporting the same DNN, a UPF location available at the SMF, a UE location information, a capability of the UPF and a functionality required for a particular UE session, a DNN, a PDU session type and if applicable, a static internet protocol (IP) address/prefix, a session and service continuity (SSC) mode selected for a PDU session, a UE subscription profile in a UDM, a DNAI as included in policy control and charging (PCC) rules, local operator policies, a S-NSSAI, an access technology being used by a UE, information related to a user plane topology and user plane terminations, identifiers of N3 terminations provided by a wireline access gateway function (W-AGF), a trusted non-3GPP gateway function (TNGF), or a trusted WLAN interworking function (TWIF), information regarding user plane interfaces of at least one UPF, information regarding at least one N3 user plane termination of an access network (AN) serving the UE, information regarding at least one N9 user plane termination of at least one UPF if needed; information regarding at least one user plane termination corresponding to at least one DNAI, a redundancy sequence number (RSN), support for redundant general packet radio service tunneling protocol-user plane (GTP-U) path or support for redundant transport path in a transport layer when a redundant UP handling is applicable, information regarding an access traffic steering, switching and splitting (ATSSS) steering capability of a UE session and information on a UPF support of round-trip time (RTT) measurements without a performance measurement functionality (PMF), a support for UPF allocation of IP address/prefix, a support of inter PLMN user plane security (IPUPS) functionality, a support for high latency communication, a support for explicit congestion notification (ECN) marking for low latency, low loss, and scalable throughput (L4S), user plane latency requirements within an application function (AF) request, and a list of supported event IDs for exposure of a UPF-related information via a service based interface.

In some embodiments, the AMF selection functionality further includes at least one of following factors for selecting an AMF set: an AMF region ID and an AMF set ID derived from a globally unique AMF ID (GUAMI), a requested NSSAI, local operator policies, 5G CIoT features indicated in a radio resource control (RRC) signaling by a UE; an integrated access and backhaul (IAB)-indication, a narrowband-Internet of things (NB-IoT) radio access technology (RAT) type; a category M indication, a new radio (NR) reduced capability (RedCap) indication, and a stand-alone non-public network (SNPN) onboarding indication as indicated in the RRC signaling by the UE. In some embodiments, the AMF selection functionality further includes at least one of following factors for selecting an AMF from an AMF set: an availability of at least one candidate AMF, at least one load balancing across candidate AMF, in a 5G-AN, 5G CIoT features indicated in an RRC signaling by a UE, and in the 5G-AN, a SNPN onboarding indication as indicated in the RRC signaling by the UE.

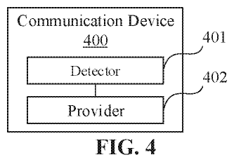

FIG. 4 illustrates a communication device according to an embodiment of the present disclosure. FIG. 4 illustrates that, in some embodiments, a communication device 400 includes a detector 401 configured to utilize a repository element to discover at least one network function (NF) instance and a provider 402 configured to provide a user equipment (UE) location information to the repository element when trying to discover the at least one NF instance, wherein a NF selection functionality in the communication device selects a NF instance and a NF service instance based on the at least one NF instance, and the NF selection functionality includes an energy cost as an input parameter for NF selection.

In some embodiments, the communication device 400 is an access and mobility management function (AMF), the repository element is a network repository function (NRF), and the NF selection functionality is a session management function (SMF) selection functionality, a user plane function (UPF) selection functionality, or an AMF selection functionality. In some embodiments, the energy cost is an index used to reflect an energy consumption of at least one SMF, at least one UPF, or at least one AMF. In some embodiments, the SMF selection functionality further includes at least one of following factors: a selected data network name (DNN), a single network slice selection assistance information (S-NSSAI), a network slice instance identifier (NSI-ID), an access technology being used by a UE, a support for control plane cellular internet-of-things (CIoT) fifth-generation system (5GS) optimization, a subscription information from a unified data management (UDM), local operator policies, load conditions of candidate SMFs, analytics for candidate SMFs' load as received from a network data analytics function (NWDAF) if the NWDAF is deployed, a UE location, a service area of the candidate SMFs, a capability of the SMF to support a multi-access (MA) protocol data unit (PDU) session, if interworking with Evolved Packet System (EPS) is required, a preference of visited SMF (V-SMF) support, a target data network access identifier (DNAI), a capability of the SMF to support user plane remote provisioning, a supported DNAI list, a HR-SBO support, and a capability of the SMF to support a non-3rd generation partnership project (3GPP) access path switching.

In some embodiments, the UPF selection functionality further includes at least one of following parameters: a UPF's dynamic load, analytics for UPF load, service experience analytics, data network (DN) performance analytics per user plane (UP) path, UE related analytics as received from a NWDAF if the NWDAF is deployed, a UPF's relative static capacity among UPFs supporting the same DNN, a UPF location available at the SMF, a UE location information, a capability of the UPF and a functionality required for a particular UE session, a DNN, a PDU session type and if applicable, a static internet protocol (IP) address/prefix, a session and service continuity (SSC) mode selected for a PDU session, a UE subscription profile in a UDM, a DNAI as included in policy control and charging (PCC) rules, local operator policies, a S-NSSAI, an access technology being used by a UE, information related to a user plane topology and user plane terminations, identifiers of N3 terminations provided by a wireline access gateway function (W-AGF), a trusted non-3GPP gateway function (TNGF), or a trusted WLAN interworking function (TWIF), information regarding user plane interfaces of at least one UPF, information regarding at least one N3 user plane termination of an access network (AN) serving the UE, information regarding at least one N9 user plane termination of at least one UPF if needed; information regarding at least one user plane termination corresponding to at least one DNAI, a redundancy sequence number (RSN), support for redundant general packet radio service tunneling protocol-user plane (GTP-U) path or support for redundant transport path in a transport layer when a redundant UP handling is applicable, information regarding an access traffic steering, switching and splitting (ATSSS) steering capability of a UE session and information on a UPF support of round-trip time (RTT) measurements without a performance measurement functionality (PMF), a support for UPF allocation of IP address/prefix, a support of inter PLMN user plane security (IPUPS) functionality, a support for high latency communication, a support for explicit congestion notification (ECN) marking for low latency, low loss, and scalable throughput (L4S), user plane latency requirements within an application function (AF) request, and a list of supported event IDs for exposure of a UPF-related information via a service based interface.

In some embodiments, the AMF selection functionality further includes at least one of following factors for selecting an AMF set: an AMF region ID and an AMF set ID derived from a globally unique AMF ID (GUAMI), a requested NSSAI, local operator policies, 5G CIoT features indicated in a radio resource control (RRC) signaling by a UE; an integrated access and backhaul (IAB)-indication, a narrowband-Internet of things (NB-IoT) radio access technology (RAT) type; a category M indication, a new radio (NR) reduced capability (RedCap) indication, and a stand-alone non-public network (SNPN) onboarding indication as indicated in the RRC signaling by the UE. In some embodiments, the AMF selection functionality further includes at least one of following factors for selecting an AMF from an AMF set: an availability of at least one candidate AMF, at least one load balancing across candidate AMF, in a 5G-AN, 5G CIoT features indicated in an RRC signaling by a UE, and in the 5G-AN, a SNPN onboarding indication as indicated in the RRC signaling by the UE.

### EXAMPLES

All principles defined by principles for network function and network function service discovery and selection can apply, while also including energy cost as an input parameter/criteria for network function (such as SMF, UPF, or AMF) selection, as following:

Principles for network function and network function service discovery and selection: NF discovery and NF service discovery enable Core Network entities (NFs or Service Communication Proxy (SCP)) to discover a set of NF instance(s) and NF service instance(s) for a specific NF service or an NF type. NF service discovery is enabled via the NF discovery procedure. Unless the expected NF and NF service information is locally configured on the requester NF, e.g. when the expected NF service or NF is in the same PLMN as the requester NF, the NF and NF service discovery is implemented via the Network Repository Function (NRF). NRF is the logical function that is used to support the functionality of NF and NF service discovery and status notification. In order for the requested NF type or NF service to be discovered via the NRF, the NF instance need to be registered in the NRF. This is done by sending a Nnrf_NFManagement_NFRegister containing the NF profile. The NF profile contains information related to the NF instance, such as NF instance ID, supported NF service instances. The registration may take place e.g. when the producer NF instance and its NF service instance(s) become operative for the first time. The NF service registration procedure.

In order for the requester NF or SCP to obtain information about the NF and/or NF service(s) registered or configured in a PLMN/slice, based on local configuration the requester NF or SCP may initiate a discovery procedure with the NRF by providing the type of the NF and optionally a list of the specific service(s) it is attempting to discover. The requester NF or SCP may also provide other service parameters e.g. slicing related information. The requester NF may also provide NF Set related information to enable reselection of NF instances within the NF set. The requester NF may also provide the required supported features of the NF. For some Network Functions which have access to the subscription data (e.g. HSS, UDM) the NRF may need to resolve the NF Group ID corresponding to a subscriber identifier. If the NRF has no stored configuration mapping identity sets/ranges to NF Group ID locally, the NRF may retrieve the NF Group ID corresponding to a specific subscriber identifier from the UDR using the Nudr_GroupIDmap_Query service operation.

In the case of Indirect Communication, a NF Service Consumer employs an SCP which routes the request to the intended target of the request. If the requester NF is configured to delegate discovery, the requester NF may omit the discovery procedure with the NRF and instead delegate the discovery to the SCP; the SCP will then act on behalf of the requester NF. In this case, the requester NF adds any necessary discovery and selection parameters to the request in order for the SCP to be able to do discovery and associated selection. The SCP may interact with the NRF to perform discovery and obtain discovery result and it may interact with the NRF or UDR to obtain NF Group ID corresponding to subscriber identifier.

The NRF provides a list of NF instances and NF service instances relevant for the discovery criteria. The NRF may provide the IP address or the FQDN of NF instance(s) and/or the Endpoint Address(es) of relevant NF service instance(s) to the NF Consumer or SCP. The NRF may also provide NF Set ID and/or NF Service Set ID to the NF Consumer or SCP. The response contains a validity period during which the discovery result is considered valid and can be cached. The result of the NF and NF service discovery procedure is applicable to any subscriber that fulfils the same discovery criteria. The entity that does the discovery may cache the NF profile(s) received from the NF/NF service discovery procedure. During the validity period, the cached NF profile(s) may be used for NF selection for any subscriber matching the discovery criteria.

In the case of Direct Communication, the requester NF uses the discovery result to select NF instance and a NF service instance that is able to provide a requested NF Service (e.g. a service instance of the PCF that can provide Policy Authorization). In the case of Indirect Communication without Delegated Discovery, the requester NF uses the discovery result to select a NF instance while the associated NF service instance selection may be done by the requester NF and/or an SCP on behalf of the requester NF. In both the cases above, the requester NF may use the information from a valid cached discovery result for subsequent selections (i.e. the requester NF does not need to trigger a new NF discovery procedure to perform the selection). In the case of Indirect Communication with Delegated Discovery, the SCP will discover and select a suitable NF instance and NF service instance based on discovery and selection parameters provided by the requester NF and optional interaction with the NRF. The NRF to be used may be provided by the NF consumer as part of the discovery parameters, e.g. as a result of a NSSF query. The SCP may use the information from a valid cached discovery result for subsequent selections (i.e. the SCP does not need to trigger a new NF discovery procedure to perform the selection).

The requester NF or SCP may subscribe to receive notifications from the NRF of a newly updated NF profile of an NF (e.g. NF service instances taken in or out of service), or newly registered de-registered NF instances. For NF and NF service discovery across PLMNs, the NRF in the local PLMN interacts with the NRF in the remote PLMN to retrieve the NF profile(s) of the NF instance(s) in the remote PLMN that matches the discovery criteria. The NRF in the local PLMN reaches the NRF in the remote PLMN by forming a target PLMN specific query using the PLMN ID provided by the requester NF.

### Example 1: For SMF Selection

The following factors may be considered during the SMF selection:
a) Selected Data Network Name (DNN). In the case of the home routed roaming, the DNN is not applied for the V-SMF selection.
b) S-NSSAI of the HPLMN (for non-roaming and home-routed roaming scenarios), and S-NSSAI of the VPLMN (for roaming with local breakout and home-routed roaming scenarios).
c) NSI-ID.

NOTE 2: The use of NSI-ID in the network is optional and depends on the deployment choices of the operator. If used, the NSI ID is associated with S-NSSAI.
d) Access technology being used by the UE.
e) Support for Control Plane CIoT 5GS Optimisation.
f) Subscription information from UDM, e.g.
   per DNN: whether LBO roaming is allowed.
   per DNN: whether HR-SBO roaming is allowed.
   per S-NSSAI: the subscribed DNN(s).
   per (S-NSSAI, subscribed DNN): whether LBO roaming is allowed.
   per (S-NSSAI, subscribed DNN): whether HR-SBO roaming is allowed.
   per (S-NSSAI, subscribed DNN): whether EPC interworking is supported.
   per (S-NSSAI, subscribed DNN): whether selecting the same SMF for all PDU sessions to the same S-NSSAI and DNN is required.
   per (S-NSSAI, DNN) associated with 5G VN group: Service Area (LADN service area) for the 5G VN group. In the case of SMF selection for a PDU Session targeting 5G VN group, the AMF may prefer candidate SMF(s) that have an intersection with the LADN service area of the 5G VN group.
g) Void.
h) Local operator policies.

NOTE 3: These policies can take into account whether the SMF to be selected is an I-SMF or a V-SMF or a SMF.
i) Load conditions of the candidate SMFs.
j) Analytics (i.e. statistics or predictions) for candidate SMFs' load as received from NWDAF, if NWDAF is deployed.
k) UE location (i.e. TA).
l) Service Area of the candidate SMFs.
m) Capability of the SMF to support a MA PDU Session.
n) If interworking with EPS is required.
o) Preference of V-SMF support. This is applicable only for V-SMF selection in the case of home routed roaming.
p) Target DNAI.
q) Capability of the SMF to support User Plane Remote Provisioning.
r) Supported DNAI list.
s) HR-SBO support.
t) Capability of the SMF (V-SMF and H-SMF) to support non-3GPP access path switching.
x) Energy Cost i.e. an index which reflects the energy consumption of the SMF nodes.

### Example 2: UPF Selection

The following parameter(s) and information may be considered by the SMF for UPF selection and re-selection:
UPF's dynamic load.
Analytics (i.e. statistics or predictions) for UPF load, Service Experience analytics and/or DN Performance analytics per UP path (including UPF and/or DNAI and/or AS instance) and UE related analytics (UE mobility, UE communication, and expected UE behavioural parameters) as received from NWDAF if NWDAF is deployed.
UPF's relative static capacity among UPFs supporting the same DNN.
UPF location available at the SMF.
UE location information.
Capability of the UPF and the functionality required for the particular UE session:

An appropriate UPF can be selected by matching the functionality and features required for an UE.
Data Network Name (DNN).
PDU Session Type (i.e. IPv4, IPv6, IPv4v6, Ethernet Type or Unstructured Type) and if applicable, the static IP address/prefix.
SSC mode selected for the PDU Session.
UE subscription profile in UDM.
DNAI as included in the PCC Rules.
Local operator policies.
S-NSSAI.
Access technology being used by the UE.
Information related to user plane topology and user plane terminations, that may be deduced from:
5G-AN-provided identities (e.g. CellID, TAI), available UPF(s) and DNAI(s);
Identifiers (i.e. a FQDN and/or IP address(es)) of N3 terminations provided by a W-AGF or a TNGF or a TWIF;
Information regarding the user plane interfaces of UPF(s). This information may be acquired by the SMF using N4;
Information regarding the N3 User Plane termination(s) of the AN serving the UE.

This may be deduced from 5G-AN-provided identities (e.g. CellID, TAI);
Information regarding the N9 User Plane termination(s) of UPF(s) if needed;
Information regarding the User plane termination(s) corresponding to DNAI(s).
RSN, support for redundant GTP-U path or support for redundant transport path in the transport layer when redundant UP handling is applicable.
Information regarding the ATSSS Steering Capability of the UE session (e.g. any combination of ATSSS-LL capability, MPTCP capability, MPQUIC capability) and information on the UPF support of RTT measurements without PMF.
   Support for UPF allocation of IP address/prefix.
      Support of the IPUPS functionality.
   Support for High latency communication.
      Support for ECN marking for L4S.
   User Plane Latency Requirements within AF request.
List of supported Event ID(s) for exposure of UPF-related information via service based interface.
Energy Cost i.e. an index which reflects the energy consumption of the UPF nodes.

NOTE 1: How the SMF determines information about the user plane network topology from information listed above, and what information is considered by the SMF, is based on operator configuration.

NOTE 2: In this release the SMF uses no additional parameters for UPF selection for a PDU Session serving TSC or Deterministic Networking. If a PDU Session needs to connect to a specific UPF hosting a specific TSN 5GS bridge or 5GS router, this can be achieved e.g. by using a dedicated DNN/S-NSSAI combination.

A W-AGF or a TNGF may provide Identifiers of its N3 terminations when forwarding over N2 uplink NAS signalling to the 5GC. The AMF may relay this information to the SMF, as part of session management signalling for a new PDU Session.

### Example 3: AMF Selection

Note that AMF is selected by RAN typically, therefore it is RAN-Core inter-domain functionality.

The AMF selection functionality in the 5G-AN may consider the following factors for selecting the AMF Set:
AMF Region ID and AMF Set ID derived from GUAMI;
   Requested NSSAI;
   Local operator policies;
5G CIoT features indicated in RRC signalling by the UE;
   IAB-indication;
   NB-IoT RAT Type;
   Category M Indication;
   NR RedCap Indication;
SNPN Onboarding indication as indicated in RRC signalling by the UE.

AMF selection functionality in the 5G-AN or CP NFs or SCP considers the following factors for selecting an AMF from AMF Set:
Availability of candidate AMF(s).
Load balancing across candidate AMF(s) (e.g. considering weight factors of candidate AMFs in the AMF Set).
In 5G-AN, 5G CIoT features indicated in RRC signalling by the UE.
In 5G-AN, SNPN Onboarding indication as indicated in RRC signalling by the UE.
Energy Cost i.e. an index which reflects the energy consumption of the AMF nodes.

NOTE: Energy Cost shall be calculated by OAM and normalized, based on Service Provider policies. It shall be communicated between OAMs of a different Network Functions/Network Function instances and it is out of the scope of this invention how exactly OAM(s) share this information between a different Network Functions/Network Function instances.

In summary, some embodiments of the present disclosure, each NF has its NF selection logic, by which the other network function, which selects it, decides on the selection principles. Per each of the NF types, and per each of the NF which selects it, a criteria of energy cost for the to-be-selected NF is introduced. One of the key service provider requirements for 5G/6G deployment is energy efficiency and lowering of energy cost. Up until 5G Rel-18, included, there are no consideration of energy cost for the NF deployment. Some embodiments of the present disclosure introduce a new NF selection criteria, based on energy cost, therefore assists service providers in their desires to make the network more efficient and to lower the energy costs, related to the network deployment. Some embodiments of the present disclosure address core network functions specifically.

Commercial interests for some embodiments are as follows. 1. Solve issues in the prior art and other issues. 2. Lower energy cost. 3. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, a network device, and/or a communication system. Compatible products follow at least one proposed solution, method, system, and apparatus of some embodiments of the present disclosure. The proposed solution, method, system, and apparatus are widely used in a UE, a base station, a network device, and/or a communication system. With the implementation of the at least one proposed solution, method, system, and apparatus of some embodiments of the present disclosure, at least one modification/improvment to methods and apparatus of energy cost leverage for network function selection are considered for standardizing.

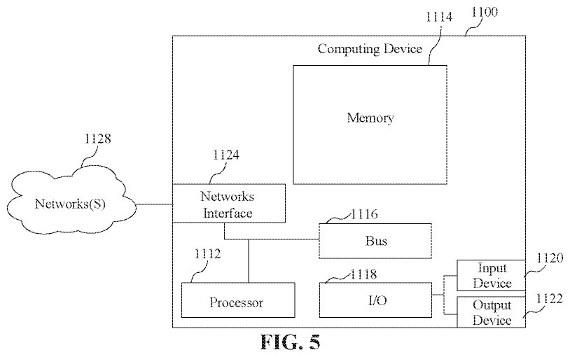

FIG. 5 is an example of a computing device 1100 according to an embodiment of the present disclosure. Any suitable computing device can be used for performing the operations described herein. For example, FIG. 5 illustrates an example of the computing device 1100 that can implement apparautes and/or methods illustrated in FIG. 1 to FIG. 4 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C #, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments illustrated in FIG. 1 to FIG. 4. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

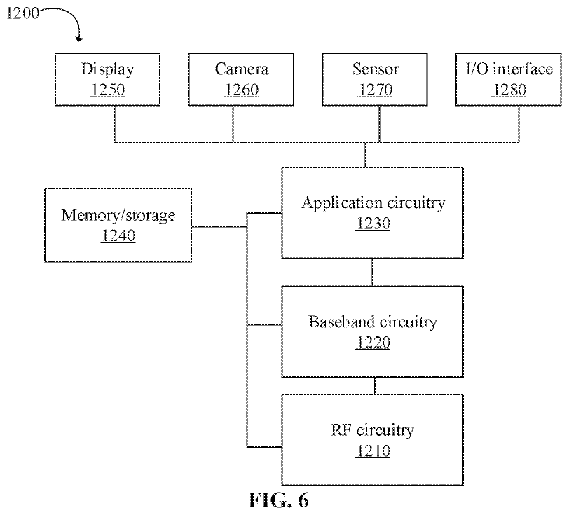

FIG. 6 is a block diagram of an example of a communication system 1200 according to an embodiment of the present disclosure. Embodiments described herein may be implemented into the communication system 1200 using any suitably configured hardware and/or software. FIG. 6 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to FIG. 1 to FIG. 4 The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to apparatuses and/or methods illustrated in FIG. 1 to FIG. 4 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an Ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A communication method for network function (NF) selection, comprising:
utilizing, by a first NF, a repository element to discover at least one NF instance; and
providing, by the first NF, a user equipment (UE) location information to the repository element when trying to discover the at least one NF instance, wherein a NF selection functionality in the first NF selects a NF instance and a NF service instance based on the at least one NF instance, and the NF selection functionality comprises an energy cost as an input parameter for NF selection.

2. The method of claim 1, wherein the first NF is an access and mobility management function (AMF), the repository element is a network repository function (NRF).

3. The method of claim 2, wherein the NF selection functionality is a session management function (SMF) selection functionality or a user plane function (UPF) selection functionality.

4. The method of claim 3, wherein the energy cost is an index used to reflect an energy consumption of at least one SMF or at least one UPF.

5. The method of claim 3, wherein the SMF selection functionality considers at least one of following factors during the SMF selection:
a support for control plane cellular internet-of-things (CIoT) fifth-generation system (5GS) optimization, load conditions of candidate SMFs, a service area of the candidate SMFs, or a capability of the SMF to support user plane remote provisioning.

6. The method of claim 5, wherein the SMF selection functionality further considers at least one of following factors during the SMF selection: a selected data network name (DNN), a single network slice selection assistance information (S-NSSAI), a network slice instance identifier (NSI-ID), an access technology being used by a UE, a subscription information from a unified data management (UDM), local operator policies, analytics for candidate SMFs' load as received from a network data analytics function (NWDAF) if the NWDAF is deployed, a UE location, a capability of the SMF to support a multi-access (MA) protocol data unit (PDU) session, if interworking with Evolved Packet System (EPS) is required, a preference of visited SMF (V-SMF) support, a target data network access identifier (DNAI), a supported DNAI list, a HR-SBO support, and a capability of the SMF to support a non-3rd generation partnership project (3GPP) access path switching.

7. The method of claim 3, wherein the UPF selection functionality considers at least one of following parameters for UPF selection: a static internet protocol (IP) address/prefix, switching and splitting (ATSSS) steering capability of a UE session, a support for UPF allocation of IP address/prefix, and a list of supported event IDs for exposure of a UPF-related information via a service based interface.

8. A communication device, comprising:
a memory for storing instructions;
a transceiver; and
a processor coupled to the memory and the transceiver,
wherein the processor is configured to execute the instructions to perform the following operations:
utilizing a repository element to discover at least one network function (NF) instance; and
providing a user equipment (UE) location information to the repository element when trying to discover the at least one NF instance, wherein a NF selection functionality in the communication device selects a NF instance and a NF service instance based on the at least one NF instance, and the NF selection functionality comprises an energy cost as an input parameter for NF selection.

9. The communication device of claim 8, wherein the communication device is an access and mobility management function (AMF), the repository element is a network repository function (NRF).

10. The communication device of claim 9, wherein the NF selection functionality is a session management function (SMF) selection functionality or a user plane function (UPF) selection functionality.

11. The communication device of claim 10, wherein the energy cost is an index used to reflect an energy consumption of at least one SMF or at least one UPF.

12. The communication device of claim 10, wherein the SMF selection functionality considers at least one of following factors during the SMF selection:
a support for control plane cellular internet-of-things (CIoT) fifth-generation system (5GS) optimization, load conditions of candidate SMFs, a service area of the candidate SMFs, or a capability of the SMF to support user plane remote provisioning.

13. The communication device of claim 12, wherein the SMF selection functionality further considers at least one of following factors during the SMF selection: a selected data network name (DNN), a single network slice selection assistance information (S-NSSAI), a network slice instance identifier (NSI-ID), an access technology being used by a UE, a subscription information from a unified data management (UDM), local operator policies, analytics for candidate SMFs' load as received from a network data analytics function (NWDAF) if the NWDAF is deployed, a UE location, a capability of the SMF to support a multi-access (MA) protocol data unit (PDU) session, if interworking with Evolved Packet System (EPS) is required, a preference of visited SMF (V-SMF) support, a target data network access identifier (DNAI), a supported DNAI list, a HR-SBO support, and a capability of the SMF to support a non-3rd generation partnership project (3GPP) access path switching.

14. The communication device of claim 10, wherein the UPF selection functionality considers at least one of following parameters for UPF selection: a static internet protocol (IP) address/prefix, switching and splitting (ATSSS) steering capability of a UE session, a support for UPF allocation of IP address/prefix, and a list of supported event IDs for exposure of a UPF-related information via a service based interface.

15. A repository element, comprising:
a memory for storing instructions;
a transceiver; and
a processor coupled to the memory and the transceiver;
wherein the processor is configured to execute the instructions to:
receive a user equipment (UE) location information provided by a first network function (NF) via the transceiver when trying to discover at least one NF instance, a NF selection functionality in the first NF selects a NF instance and a NF service instance based on the at least one NF instance, and the NF selection functionality comprises an energy cost as an input parameter for NF selection.

16. The repository element of claim 15, wherein the first NF is an access and mobility management function (AMF), the repository element is a network repository function (NRF).

17. The repository element of claim 16, wherein the NF selection functionality is a session management function (SMF) selection functionality or a user plane function (UPF) selection functionality.

18. The repository element of claim 17, wherein the energy cost is an index used to reflect an energy consumption of at least one SMF or at least one UPF.

19. The repository element of claim 17, wherein the SMF selection functionality considers at least one of following factors during the SMF selection:
a support for control plane cellular internet-of-things (CIoT) fifth-generation system (5GS) optimization, load conditions of candidate SMFs, a service area of the candidate SMFs, or a capability of the SMF to support user plane remote provisioning.

20. The repository element of claim 16, wherein the UPF selection functionality considers at least one of following parameters for UPF selection: a static internet protocol (IP) address/prefix, switching and splitting (ATSSS) steering capability of a UE session, a support for UPF allocation of IP address/prefix, and a list of supported event IDs for exposure of a UPF-related information via a service based interface.
